(19) United States
(12) Patent Application Publication
(10) Pub. No.: US 2026/0297388 A1
(43) Pub. Date: Oct. 1, 2026

(54) SYNTACTIC FOAM COMPOSITIONS

(71) Applicant: PRC-Desoto International, Inc., Sylmar, CA (US)

(72) Inventors: Jiancheng Liu, Arcadia, CA (US); Renhe Lin, Santa Clarita, CA (US)

(73) Assignee: PRC-Desoto International, Inc., Sylmar, CA (US)

(21) Appl. No.: 19/476,758

(22) PCT Filed: Apr. 21, 2024
(86) PCT No.: PCT/US2024/025614

§ 371 Date: Oct. 20, 2025

Related U.S. Application Data
(60) Provisional application No. 63/497,303, filed on Apr. 20, 2023.

(51) Int. Cl. C09J 5/08; B05D 1/26; C08G 59/24; C08G 59/30; C08G 59/42; C08G 59/50; C08G 59/56; C08G 59/62; C08K 3/36; C08L 63/00; C09J 163/00

(52) U.S. Cl. CPC C09J 5/08; B05D 1/265; C08G 59/245; C08G 59/306; C08G 59/4207; C08G 59/4284; C08G 59/502; C08G 59/56; C08G 59/621; C08K 3/36; C09J 163/00; B05D 2202/25; B05D 2202/45; B05D 2504/00; C08G 2150/00; C08G 2170/60; C08L 63/00; C08L 2207/53

(57) ABSTRACT

Disclosed herein are multi-component compositions comprising: a first component comprising: an epoxy-functional compound; elastomeric particles; and a (meth)acrylic-functional compound; and a second component comprising: an amine-functional curing agent. Also disclosed herein are methods of coating a substrate. Also disclosed are substrates comprising a coating formed on a surface thereof, wherein the coating is formed from one of the multi-component compositions disclosed herein. Also disclosed are methods of forming an article comprising extruding the multi-component compositions disclosed herein. Also disclosed are uses of the multi-component compositions and the coatings formed therefrom.

### CROSS-REFERENCE TO RELATED APPLICATIONS

This application claims priority to U.S. Provisional Application No. 63/497,303 filed on Apr. 20, 2023 and entitled “Syntactic Foam Compositions,” incorporated herein in its entirety.

### FIELD

The present disclosure relates to compositions and coatings formed therefrom.

### BACKGROUND

Coatings useful in aerospace and other applications must satisfy demanding mechanical, chemical, and environmental requirements. The coatings can be applied to a variety of surfaces including metal surfaces, intermediate coatings, and finished coatings.

### SUMMARY

Disclosed herein are multi-component compositions comprising: a first component comprising: an epoxy-functional compound; elastomeric particles; and a (meth)acrylic-functional compound; and a second component comprising: an amine-functional curing agent.

Also disclosed herein are methods of coating a substrate comprising contacting at least a portion of a surface of the substrate with one of the multi-component compositions disclosed herein.

Also disclosed herein are substrates comprising a coating formed on a surface thereof, wherein the coating is formed from one of the multi-component compositions disclosed herein.

Also disclosed herein are methods of forming an article comprising extruding the multi-component compositions disclosed herein.

### DETAILED DESCRIPTION

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient, or method step. As used herein, “consisting essentially of” is understood in the context of this application to include the specified elements, materials, or ingredients or method steps “and those that do not materially affect the basic and novel characteristic(s)” of what is being described. As used herein, open-ended terms include closed terms such as consisting essentially of and consisting of.

In this application, the use of the singular includes the plural, and the plural encompasses the singular, unless specifically stated otherwise. For example, although reference is made herein to “an” amine-containing compound or “a” furan-containing compound, a combination (i.e., a plurality) of these components may be used.

In addition, in this application, the use of “or” means “and/or” unless specifically stated otherwise, even though “and/or” may be explicitly used in certain instances.

As used herein, the terms “on,” “onto,” “applied on,” “applied onto,” “formed on,” “deposited on,” “deposited onto,” and the like mean formed, overlaid, deposited, or provided on, but not necessarily in contact with, a substrate surface. For example, a composition “applied onto” a substrate surface does not preclude the presence of one or more other intervening coating layers or films of the same or different composition located between the composition and the substrate surface.

As used herein, a “coating composition” refers to a composition, e.g., a solution, mixture, or a dispersion, that, in an at least partially dried or cured state, is capable of producing a film, layer, or the like on at least a portion of a substrate surface.

As used herein, a “sealant composition” refers to a coating composition, e.g., a solution, mixture, or a dispersion that, in an at least partially dried or cured state, has the ability to resist atmospheric conditions such as temperature and moisture gradients and particulate matter, such as moisture and temperature and at least partially block the transmission of materials, such as particulates, water, fuel, and other liquids and gasses.

As used herein, an “adhesive composition” refers to a coating composition, e.g., a solution, mixture, or a dispersion, that, in an at least partially dried or cured state, produces a load-bearing joint, such as a load-bearing joint having a lap shear strength of at least 72.5 psi measured according to ASTM D1002 using an Instron 5567 machine in tensile mode with a pull rate of 1.3 mm per minute.

As used herein, a “structural adhesive composition” refers to a coating composition, e.g., a solution, mixture, or a dispersion, that, in an at least partially dried or cured state, produces a structural adhesive, i.e., a load-bearing joint, such as a load-bearing joint having a lap shear strength of at least 725 psi measured according to ASTM D1002 using an Instron 5567 machine in tensile mode with a pull rate of 1.3 mm per minute.

As further defined herein, ambient conditions generally refer to room temperature (e.g., 23° C.) and humidity conditions or temperature and humidity conditions that are typically found in the area in which the composition is applied to a substrate, e.g., at 10° C. to 40° C. and 5% to 80% relative humidity, while slightly thermal conditions are temperatures that are slightly above ambient temperature, such as 40° C. to 60° C.

As used herein, the term “multi-component” refers to a composition in which at least a portion of the reactive components readily associate to form an interaction or react to form a bond (physically or chemically), and at least partially cure without activation from an external energy source, such as at ambient or slightly thermal conditions, when mixed. One of skill in the art understands that at least two of the multiple components of the composition are stored separately from each other and mixed just prior to application of the composition. Multi-component compositions include compositions comprising at least two components (a “two component” or “2K” composition), such as at least three components, and so forth. Optionally may be heated or baked, as described below.

As used herein, the terms “cure,” “cured,” or similar terms, means that the reactive functional groups of the components that form the composition react to form a film, layer, or bond. As used herein, “curing” of the curable composition refers to subjecting said composition to curing conditions leading to reaction of the reactive functional groups of the components of the composition and resulting in the crosslinking of the components of the composition and formation of an at least partially cured film, layer, or bond. As used herein, a “curable” composition refers to a composition that may be cured. In the case of a 2K composition, the composition is at least partially cured or cured when the components of the composition are mixed resulting in the reaction of the reactive functional groups of the components of the composition. The curable composition may also be subjected to curing conditions such that a substantially complete cure is attained and wherein further curing results in no significant further improvement in the coating properties such as, for example, increased lap shear performance.

As used herein, “polymer” refers to oligomers, homopolymers and copolymers.

As used herein, “backbone” means the longest series of covalently bound atoms which forms the continuous chain of the polymer.

As used herein, “(meth)acrylate” and like terms refers to both the acrylate and the corresponding methacrylate terminated monomer, oligomer, polymer.

As used herein, “functional group” means specific groups of atoms within a molecule that have the potential to undergo chemical reactions under certain conditions, regardless of the other atoms in the molecule.

As used herein, the term “(meth)acrylic-functional compound” refers to a compound that includes at least two unreacted (meth)acrylic functional groups per molecule. As used herein, “unreacted acrylic functional group” refers to a group comprising the following structure:

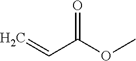

and “unreacted methacrylic functional group” refers to a group comprising the following structure:

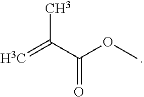

As used herein, “glass transition temperature” or “Tg” means the temperature at which the polymer or polymer-containing composition changes from a rigid glassy material to a soft material. One skilled in the art would understand that glass transition occurs over a range of temperatures and that the recited value is an approximation of the center of that range.

As used herein, the term “accelerator” means a substance that increases the rate or decreases the activation energy of a chemical reaction in comparison to the same reaction in the absence of the accelerator. An accelerator may be either a “catalyst,” that is, without itself undergoing any permanent chemical change, or may be reactive, that is, capable of chemical reactions and includes any level of reaction from partial to complete reaction of a reactant.

As used herein, unless indicated otherwise, the term “substantially free” means that a particular material is not purposefully added to a mixture or composition, respectively, and is present only as an impurity in a trace amount of less than 5 percent by weight based on a total weight of the mixture or composition, respectively. As used herein, unless indicated otherwise, the term “essentially free” means that a particular material is present only in an amount of less than 2 percent by weight based on a total weight of the mixture or composition, respectively. As used herein, unless indicated otherwise, the term “completely free” means that a mixture or composition, respectively, does not comprise a particular material, i.e., the mixture or composition comprises 0 percent by weight of such material.

The present disclosure is directed to a multi-component composition comprising, or consisting essentially of, or consisting of, a first component and a second component. The composition optionally may comprise additional components. The first component may comprise, or consist essentially of, or consist of, an epoxy-functional compound, elastomeric particles, and a (meth)acrylate-functional compound. The second component may comprise, or consist essentially of, or consist of, an amine-functional curing agent. The first component, second component, and/or third or higher components also may comprise any of the additional optional components disclosed herein.

### Enoxy-Functional Compounds

Compositions disclosed herein can comprise a polyepoxide compound or a combination of polyepoxide compounds. A polyepoxide refers to a compound having two or more reactive epoxy groups. A polyepoxide can be difunctional or can include a combination of polyepoxides having different epoxy functionalities. A polyepoxide may include a combination of polyepoxides. A polyepoxide resin can be liquid at room temperature.

Examples of suitable polyepoxide compounds include hydantoin diepoxide, a diglycidyl ether of bisphenol-A, a diglycidyl ether of bisphenol-F, a novolac-type polyepoxide, epoxidized unsaturated phenolic resins, dimer acid-based epoxy resins, and combinations of any of the foregoing.

Other examples of suitable polyepoxides include a bisphenol A type polyepoxide, a brominated bisphenol A type polyepoxide, a bisphenol F type polyepoxide, a biphenyl type polyepoxide, a novolac type polyepoxide, an alicyclic polyepoxide, a naphthalene type polyepoxide, an ether or polyether polyepoxide, an oxirane ring-containing polybutadiene, and a silicone polyepoxy copolymer.

Additional examples of suitable polyepoxides include a bisphenol A type polyepoxide having an average molecular weight, for example of 400 Daltons or less 600 Daltons or less, 1,000 Daltons or less, 1,200 Daltons or less, or 1,400 Daltons or less; a branched polyfunctional bisphenol A type polyepoxide such as p-glycidyloxyphenyl dimethyltolylbisphenol A diglycidyl ether; a bisphenol F type epoxy resin; a phenol novolac type polyepoxide having an average molecular weight, for example, of 500 Daltons or less, 700 Daltons or less, 1,000 Daltons or less, or 1,500 Daltons or less; an alicyclic polyepoxide such as amyl(3,4-cyclohexene)dioxide, methyl 3,4-epoxycyclohexylcarboxylate (3,4-epoxycyclohexyl), bis(3,4-epoxy-6-methylcyclohexylmethyl) adipate and 2-(3,4-epoxycyclohexyl)-5, 1-spiro(3,4-epoxycyclohexyl)-m-dioxane; a biphenyl type polyepoxide such as 3,3′,5,5′-tetramethyl-4,4′-diglycidyloxybiphenyl; a glycidyl ester type polyepoxide such as diglycidyl hexahydrophthalate, diglycidyl 3-methylhexahydrophthalate and diglycidyl hexa hydroterephthatate; a glycidylamine type polyepoxide such as diglycidylaniline, diglycidyltoluidine, triglycidyl-p-aminophenol, tetraglycidyl-m-xylene diamine, tetraglycidylbis(aminomethyl)cyclohexane; a hydantoin type polyepoxide such as 1,3-diglycidyl-5-methyl-5-ethylhydantoin; and a naphthalene ring-containing polyepoxide. Also, a polyepoxide having silicone such as 1,3-bis(3-glycidoxy-propyl)-1,1,3,3-tetramethyldisiloxane may be used.

Examples of commercially available polyepoxides suitable for use in the compositions disclosed herein include polyglycidyl derivatives of phenolic compounds, such as those available under the trade names EPON™ 824, EPON™ 825, EPON™ 826, EPON™ 82.7, EPO™ 828, EPON™ 829, EPON™ 830, EPON™ 834, EPON™ 862, EPON™ 863, EPON™ 8280, EPON™ 8281, EPON™ 872, an EPON™ resin blend, EPON™ 1001-A-80, EPON™ 1001-B-80, EPON™ 1001-CX-75, EPON™ 1001-DNT-75, EPON™ 1001-FT-75, EPON™ 1001-G-70, EPON™ 1001-H-75, EPON™ 1001-K-65, EPON™ 1001-O-75, EPON™ 1001-T-75, EPON™ 1001-UV-70, EPON™ 1001-X-75, EPON™ 1004-O-65, EPON™ 1007-CT-55, EPON™ 1007-FMU-50, EPON™1007-HT-55, EPON™ 1009-DU-40, EPON™ 1009-MX-40, and other EPON™ epoxy resins, available, for example, from Momentive Specialty Chemicals Inc. and/or from Resolution Performance Products LLC; and DER™ 331, DER™ 332, DER™ 334, DER™ 354, DER™ 383 and DER™ 542 from Dow Chemical Co. Other suitable polyepoxides include polyepoxides prepared from polyols and poly glycidyl derivatives of phenol-formaldehyde novolacs, the latter of which are commercially available under the trade names DEN™ 431, DEN′™ 438, and DEN′™ 439 from Dow Chemical Company. Cresol analogs are also available commercially ECN™ 1235, ECN™ 1273, and ECN™ 1299 from Ciba Specialty Chemicals, inc. SU-8 is a bisphenol A-type epoxy Novolac available from Resolution.

Performance Products LLC. Polyglycidyl adducts of amines, amino alcohols and polycarboxylic acids are also useful in the compositions disclosed herein, commercially available resins of which include GLY AMIN E™ 135, GLY AMINE™ 125, and GLY AMINE™ 115; ARALDITE™ MY-720, ARALDITE™ MY-721, ARALDITE™ 0500, and ARALDITE™ 0510 from Ciba Specialty Chemicals, Inc. and PGA-X and PGA-C.

A polyepoxide can include a combination of polyepoxides.

A polyepoxide can comprise a hydroxyl-functional polyepoxide or combination of hydroxyl-functional polyepoxides. For example, a polyepoxide can comprise a hydroxyl-functional diglycidyl ether of bisphenol A.

A diglycidyl ether of bisphenol A can comprise pendent hydroxyl groups such as, for example, from 1 to 10 pendent hydroxyl groups, from 1 to 8 hydroxyl groups, from 1 to 6 hydroxyl groups, from 1 to 4 pendent hydroxyl groups, or from 1 to 2 pendent hydroxyl groups, such as 1, 2, 3, 4 5, or 6 pendent hydroxyl groups. A diglycidyl ether of bisphenol A having pendent hydroxyl groups can be referred to as hydroxyl-functional diglycidyl ether of bisphenol A.

Hydroxyl-functional diglycidyl ethers of bisphenol A can have an epoxy equivalent weight from 400 Daltons to 1,500 Daltons, from 400 Daltons to 1,000 Daltons or from 400 Daltons to 600 Daltons.

A diglycidyl ether of bisphenol A can comprise a diglycidyl ether of bisphenol A without a hydroxyl-functional component, a diglycidyl ether of bisphenol A which can be partly hydroxyl-functional, or all of the diglycidyl ether of bisphenol A can be hydroxyl-functional.

A diglycidyl ether of bisphenol A having hydroxyl pendent groups can have the structure.

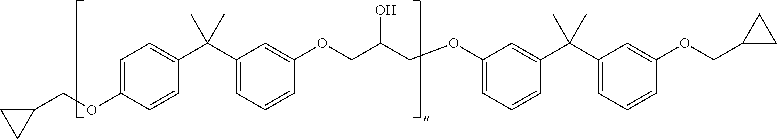

where n is an integer 1 to 6.

Examples of suitable diglycidyl ethers of bisphenol A include bisphenol A polyepoxides in which n is an integer 1 to 6, or a combination of bisphenol A polyepoxides in which n can be a non-integer value, for example, 0.1 to 2.9, 0.1 to 2.5, 0.1 to 2.1, 0.1 to 1.7, 0.1 to 1.5, 0.1 to 1.3, 0.1 to 1.1, 0.1 to 0.9, 0.3 to 0.8, or 0.5 to 0.8.

A diglycidyl ether of bisphenol A comprising hydroxyl pendent groups can comprise, for example, a 2,2-bis(p-glycidyloxyphenyl)propane condensation product with 2,2-bis(p-hydroxyphenyl)propane and similar isomers. Suitable diglycidyl ethers of bisphenol A comprising hydroxyl pendent groups are available, for example, from Momentive and include EPON™ solid epoxy resins such as EPON™ 100 IF, EPON™ 1002F, EPON™ 1004F, EPON™ 1007F, EPON™ 1009F, and combinations of any of the foregoing. Such diglycidyl ethers of bisphenol A may be provided, for example, as a 70 wt % to 95 wt % solids solution in a suitable solvent such as methyl ethyl ketone. Such high solids content resins include, for example, EPON™ 1001-A-80, EPON™ 1001-B-80, EPON™ 1001-CX-75, EPON™ 1001-DNT-75, EPON™ 1001-FT-75, EPON™ 1001-G-70, EPON™ 1001-H-75, EPON™ 1001-K-65, EPON™ 1001-O-75, EPON™ 1001-T-75, EPON™ 1001-UY-70, EPON™ 1001-X-75, EPON™ 1004-O-65, EPON™ 1007-CT-55, EPON™ 1007-FMU-50. EPON™ 1007-HT-55, EPON™ 1001-DU-40, EPON™ 1009-MX-840, or a combination of any of the foregoing.

Examples of suitable epoxy novolac resins include novolac polyepoxides in which n is an integer 1 to 6, 1 to 4, or 1 to 2; or in which n can be a non-integer value, for example, 0.1 to 2.9, 0.1 to 2.5, 0.1 to 2.1, 0.1 to 1.7, 0.1 to 1.5, 0.1 to 1.3, 0.1 to 1.1, 0.1 to 0.9, 0.3 to 0.8, or from 0.5 to 0.8.

A polyepoxide can comprise, for example, a difunctional polyepoxide, a polyepoxide having an epoxy functionality greater than 2 such as 3 to 6, or a combination thereof. A polyepoxide can have an average epoxy functionality, for example, 2.1 to 3.5, 2.2 to 3.4, 2.6 to 3.2, or 2.7 to 3.1.

A polyepoxide can comprise, for example, a combination of a difunctional polyepoxide or combination of difunctional polyepoxides, a trifunctional polyepoxide or combination of trifunctional polyepoxides, or a combination of any of the foregoing.

A difunctional polyepoxide can have an epoxy equivalent weight, for example, from 400 Daltons to 1,500 Daltons, from 400 Daltons to 1,000 Daltons, or from 400 Daltons to 600 Daltons.

A trifunctional polyepoxide can have an epoxy equivalent weight, for example, from 140 Daltons to 500 Daltons, from 150 Daltons to 300 Daltons, or from 160 Daltons to 200 Daltons.

A difunctional polyepoxide can comprise, for example, a hydroxyl-functional polyepoxide and a trifunctional polyepoxide can comprise a hydroxyl-functional polyepoxide.

A composition can comprise, for example, a hydroxyl-functional polyepoxide and a trifunctional polyepoxide that does not contain pendent hydroxyl groups; or a composition can comprise a difunctional polyepoxide that does not contain pendent hydroxyl groups, and a hydroxyl-functional trifunctional polyepoxide.

A difunctional polyepoxide can comprise a hydroxyl-functional polyepoxide.

Compositions provided by the present disclosure can comprise a combination of polyepoxides. A combination of polyepoxides can comprise polyepoxides having different polyepoxides having different functionalities or different average functionalities. A combination of polyepoxides can comprise polyepoxides having an average epoxy functionality of at least 2. A combination of polyepoxides can comprise polyepoxides having an average epoxy functionality of no more than 3, such as no more than 2.9, such as no more than 2.8, such as no more than 2.7, such as no more than 2.5, such as no more than 2.3. A combination of polyepoxides can comprise polyepoxides having an average epoxy functionality of 2 to 3, such as 2 to 2.3, such as 2 to 2.5, such as 2 to 2.7, such as 2 to 2.8, such as 2 to 2.9.

The multi-component compositions disclosed herein may comprise an epoxy-functional compound in an amount of at least 0.5 percent by weight based on total weight of the multi-component composition, such as at least 5 percent by weight. The multi-component compositions disclosed herein may comprise an epoxy-functional compound in an amount of no more than 60 percent by weight based on total weight of the multi-component composition, such as no more than 40 percent by weight. The multi-component compositions disclosed herein may comprise an epoxy-functional compound in an amount of 0.5 percent by weight to 60 percent by weight based on total weight of the multi-component composition, such as 5 percent by weight to 40 percent by weight.

### Elastomeric Particles

The epoxy-containing compound of the composition may further include elastomeric particles. As used herein, “elastomeric particles” refers to particles having a glass transition temperature (Tg) of −70° C. to 0° C. as measured by Differential Scanning Calorimetry (DSC) or Dynamic Mechanical Analysis (DMA).

The elastomeric particles may be included in an epoxy carrier resin for introduction into the coating composition. The elastomeric particles may be phase-separated from the epoxy in the epoxy-containing compound. As used herein, the term “phase-separated” means forming a discrete domain within a matrix of the epoxy-containing compound.

The elastomeric particles may have a core/shell structure. The core of the core-shell particles may comprise a Tg of less than 0° C., such as −20° C. or less, such as −40° C. or less, such as −60° C. or less as measured by DMA or DSC.

Suitable elastomeric particles may be comprised of a silicone material. Suitable elastomeric particles may be comprised of a (meth)acrylic shell and an elastomeric core. The core may comprise natural or synthetic rubbers, polybutadiene, styrene-butadiene, polyisoprene, styrene isoprene, chloroprene, acrylonitrile butadiene, butyl rubber, polysiloxane, polysulfide, ethylene-vinyl acetate, fluoroelastomer, polyolefin, hydronated styrene-butadiene, or combinations thereof. The type of elastomeric particles and the concentration thereof is not limited as long as the particle size falls within the specified range as illustrated below.

The average particle size of the elastomeric particles may be, for example, 0.02 microns to 5 microns (20 nm to 5,000 nm), such as 20 nm to 500 nm, such as 50 nm to 250 nm, the reported particle sizes for rubber particles provided by Kaneka Texas Corporation, as measured by standard techniques known in the industry. Suitable methods of measuring particles sizes disclosed herein include, for example, as measured by transmission electron microscopy (TEM). Suitable methods of measuring particle sizes by TEM include suspending elastomeric particles in a solvent selected such that the particles do not swell, and then drop-casting the suspension onto a TEM grid which is allowed to dry under ambient conditions. For example, epoxy resin containing core-shell elastomeric particles may be diluted in butyl acetate for drop casting and measurements may be obtained from images acquired from a Tecnai T20 TEM operating at 200 kV and analyzed using ImageJ software, or an equivalent solvent, instrument and software.

In an example, suitable finely dispersed core-shell elastomeric particles having an average particle size ranging from 50 nm to 250 nm may be pre-mixed or pre-dispersed in the a resin, such as in epoxy resin such as aromatic epoxides, phenolic novolac epoxy resin, bisphenol A and/or bisphenol F diepoxide, and/or aliphatic epoxides, which include cyclo-aliphatic epoxides, at concentrations ranging from 5% to 40% rubber particles by weight based on the total weight of the rubber dispersion, such as from 20% to 35%. Suitable epoxy resins may also include a mixture of epoxy resins. When utilized, the epoxy carrier resin may be an epoxy-containing component such that the weight of the epoxy-containing component present in the composition includes the weight of the epoxy carrier resin.

Exemplary non-limiting commercial core-shell elastomeric particle products using poly(butadiene) rubber particles that may be utilized in the composition include core-shell poly(butadiene) rubber powder (commercially available as PARALOID™ EXL 2650A from Dow Chemical), a core-shell poly(butadiene) rubber dispersion (25% core-shell rubber by weight) in bisphenol F diglycidyl ether (commercially available as Kane Ace MX 136), a core-shell poly(butadiene) rubber dispersion (33% core-shell rubber by weight) in Epon® 828 (commercially available as Kane Ace MX 153), a core-shell poly(butadiene) rubber dispersion (33% core-shell rubber by weight) in Epiclon® EXA-835LV (commercially available as Kane Ace MX 139), a core-shell poly(butadiene) rubber dispersion (37% core-shell rubber by weight) in bisphenol A diglycidyl ether (commercially available as Kane Acc MX 257), and a core-shell poly(butadiene) rubber dispersion (37% core-shell rubber by weight) in Epon® 863 (commercially available as Kane Ace MX 267), and core-shell poly(butadiene) rubber dispersion (40% rubber by weight) in bisphenol A diglycidyl ether (commercially available as Kane Ace MX 150), each available from Kaneka Texas Corporation, and acrylic rubber dispersions.

Exemplary non-limiting commercial core-shell elastomeric particle products using styrene-butadiene rubber particles that may be utilized in the composition include a core-shell styrene-butadiene rubber powder (commercially available as CLEARSTRENGTH® XT100 from Arkema), core-shell styrene-butadiene rubber powder (commercially available as PARALOID™ EXL 2650J), a core-shell styrene-butadiene rubber dispersion (33% core-shell rubber by weight) in bisphenol A diglycidyl ether (commercially available as Fortegra™ 352 from Olin™), core-shell styrene-butadiene rubber dispersion (33% rubber by weight) in low viscosity bisphenol A diglycidyl ether (commercially available as Kane Ace MX 113), a core-shell styrene-butadiene rubber dispersion (25% core-shell rubber by weight) in bisphenol A diglycidyl ether (commercially available as Kane Ace MX 125), a core-shell styrene-butadiene rubber dispersion (25% core-shell rubber by weight) in bisphenol F diglycidyl ether (commercially available as Kane Ace MX 135), a core-shell styrene-butadiene rubber dispersion (25% core-shell rubber by weight) in D.E.N.™-438 phenolic novolac epoxy (commercially available as Kane Ace MX 215), a core-shell styrene-butadiene rubber dispersion (25% core-shell rubber by weight) in Araldite® MY-721 multi-functional epoxy (commercially available as Kane Ace MX 416), a core-shell styrene-butadiene rubber dispersion (25% core-shell rubber by weight) in MY-0510 multi-functional epoxy (commercially available as Kane Ace MX 451), a core-shell styrene-butadiene rubber dispersion (25% core-shell rubber by weight) in Syna Epoxy 21 Cyclo-aliphatic Epoxy from Synasia (commercially available as Kane Ace MX 551), and a core-shell styrene-butadiene rubber dispersion (25% core-shell rubber by weight) in polypropylene glycol (MW 400) (commercially available as Kane Ace MX 715), each available from Kaneka Texas Corporation. Other commercially available core-shell rubber particle dispersions include Fortegra 352 (33% core-shell rubber particles by weight in bisphenol A liquid epoxy resin), available from Olin Corporation. Other commercially available core-shell rubber particle dispersions include Paraloid™ EXL 2650A (core-shell poly(butadiene) commercially available from Dow.

Exemplary non-limiting commercial core-shell elastomeric particle products using polysiloxane rubber particles that may be utilized in the composition include a core-shell polysiloxane rubber powder (commercially available as GENIOPERL® P52 from Wacker), a core-shell polysiloxane rubber dispersion (40% core-shell rubber by weight) in bisphenol A diglycidyl ether (commercially available as ALBIDUR® EP2240A from Evonick), a core-shell polysiloxane rubber dispersion (25% core-shell rubber by weight) in jER™ 828 (commercially available as Kane Ace MX 960), a core-shell polysiloxane rubber dispersion (25% core-shell rubber by weight) in Epon® 863 (commercially available as Kane Ace MX 965) each available from Kaneka Texas Corporation.

The composition may comprise the elastomeric particles in an amount of at least 2 percent by weight based on the total weight of the multi-component composition, such as at least 3 percent by weight, such as at least 5 percent by weight. The composition may comprise the elastomeric particles in an amount of no more than 40 percent by weight based on total weight of the multi-component composition, such as no more than 35 percent by weight, such as no more than 25 percent by weight. The composition may comprise the elastomeric particles in an amount of 2 percent by weight to 40 percent by weight based on total weight of the multi-component composition, such as 3 percent by weight to 35 percent by weight, such as 5 percent by weight to 25 percent by weight.

### (Meth)Acrylic-Functional Compounds

The multi-component composition may comprise a (meth)acrylic-functional compound. The (meth)acrylic-functional compound comprises a monomer, oligomer or polymer that includes at least two unreacted (meth)acrylic functional groups per molecule. The (meth)acrylic-functional compound may comprise a monomer, oligomer or polymer that includes at least three (meth)acrylic-functional groups per molecule.

Suitable (meth)acrylic-functional compounds include ethylene glycol di(meth)acrylate, hexanediol di(meth)acrylate, tetraethylene glycol di(meth)acrylate, and/or tripropylene glycol di(meth)acrylate. Suitable monomers having three or more ethylenically unsaturated groups per molecule include ethoxylated trimethylolpropane triacrylate having 0 to 20 ethoxy units, [ethoxylated]trimethylolpropane trimethacrylate having 0 to 20 ethoxy units, di-pentacrythritoltriacrylate, pentacrythritol tetraacrylate, and/or di-pentacrythritolpentaacrylate.

Suitable (meth)acrylic-functional compounds include di-, tri-, or other polyacrylates and methacrylates such as glycerol diacrylate, ethoxylated bisphenol A dimethacrylate (D-zethacrylate), tetraethylene glycol dimethacrylate (TEGDMA), polyethyleneglycol dimethacrylate (PEGDMA), glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis[1-(3-acryloxy-2-hydroxy)]-p-propoxyphenyldimethylmethane, and trishydroxyethyl-isocyanurate trimethacrylate; bis-acrylates of polyesters (e.g., methacrylate-terminated polyesters); the bis-acrylates and bis-methacrylates of polyethylene glycols of molecular weight 200-500, copolymerizable mixtures of acrylated monomers such as those in U.S. Pat. No. 4,652,274, acrylated oligomers such as those of U.S. Pat. No. 4,642,126; and polyfunctional (meth)acrylates comprising urea or amide groups, such as those of EP 2008636; all incorporated herein by reference.

The (meth)acrylic compound may comprise one or more poly(meth)acrylates, for example, di-, tri-, tetra- or pentafunctional monomeric or oligomeric aliphatic, cycloaliphatic, or aromatic acrylates or methacrylates.

Examples of suitable aliphatic poly(meth)acrylates having more than two (meth)acrylate groups in their molecules are the triacrylates and trimethacrylates of hexane-2,4,6-triol; glycerol or 1,1,1-trimethylolpropane; ethoxylated or propoxylated glycerol or 1,1,1-trimethylolpropane; and the hydroxyl-containing tri(meth)acrylates which are obtained by reacting triepoxide compounds, for example the triglycidyl ethers of said triols, with (meth)acrylic acid. It is also possible to use, for example, pentaerythritol tetraacrylate, bistrimethylolpropane tetraacrylate, pentaerythritol monohydroxytriacrylate or -methacrylate, or dipentaerythritol monohydroxypentaacrylate or -methacrylate.

Another suitable class of (meth)acrylic compounds includes aromatic di(meth)acrylate compounds and trifunctional or higher functionality (meth)acrylate compounds. Trifunctional or higher functionality meth(acrylates) can be tri-, tetra- or pentafunctional monomeric or oligomeric aliphatic, cycloaliphatic, or aromatic acrylates or methacrylates.

Examples of suitable aliphatic tri-, tetra- and pentafunctional (meth)acrylates are the triacrylates and trimethacrylates of hexane-2,4,6-triol; glycerol or 1,1,1-trimethylolpropane; ethoxylated or propoxylated glycerol or 1,1,1-trimethylolpropane; and the hydroxyl-containing tri(meth)acrylates which are obtained by reacting triepoxide compounds, for example the triglycidyl ethers of said triols, with (meth)acrylic acid. It is also possible to use, for example, pentaerythritol tetraacrylate, bistrimethylolpropane tetraacrylate, pentaerythritol monohydroxytriacrylate or -methacrylate, or dipentaerythritol monohydroxypentaacrylate or -methacrylate. Tri(meth)acrylates may comprise 1,1-trimethylolpropane triacrylate or methacrylate, ethoxylated or propoxylated 1,1,1-trimethylolpropanetriacrylate or methacrylate, ethoxylated or propoxylated glycerol triacrylate, pentaerythritol monohydroxy triacrylate or methacrylate, or tris(2-hydroxy ethyl) isocyanurate triacrylate. Further examples of suitable aromatic tri(meth)acrylates are the reaction products of triglycidyl ethers of trihydroxy benzene and phenol or cresol novolaks containing three hydroxyl groups, with (meth)acrylic acid.

In some cases, a the (meth)acrylic compound comprises diacrylate and/or dimethacrylate esters of aliphatic, cycloaliphatic or aromatic diols, including 1,3- or 1,4-butanediol, neopentyl glycol, 1,6-hexanediol, dodecane diol, diethylene glycol, triethylene glycol, tetraethylene glycol, polyethylene glycol, tripropylene glycol, ethoxylated or propoxylated neopentyl glycol, 1,4-dihydroxymethylcyclohexane, 2,2-bis(4-hydroxycyclohexyl)propane or bis(4-hydroxycyclohexyl)methane, hydroquinone, 4,4′-dihydroxybiphenyl, bisphenol A, bisphenol F, bisphenol S, ethoxylated or propoxylated bisphenol A, ethoxylated or propoxylated bisphenol F or ethoxylated or propoxylated bisphenol S. In some cases, a (meth)acrylic compound described herein comprises one or more higher functional acrylates or methacrylates such as dipentaerythritol monohydroxy pentaacrylate or bis(trimethylolpropane)tetraacrylate.

The (meth)acrylic-functional compound may comprise functional groups in addition to the (meth)acrylic functional groups. Such functional groups include a hydroxyl group, an epoxy group, an isocyanato group, a tertiary amino group, an ether linkage, and/or an ester linkage.

The (meth)acrylic-functional compound may comprise a hydroxyl-functional (meth)acrylate. As used herein the term “hydroxyl-functional (meth)acrylate” collectively refers (meth)acrylates which have hydroxyl functionality, i.e., comprise at least one hydroxyl functional group in the molecule. The hydroxyl-functional (meth)acrylate may comprise a hydroxyalkyl (meth)acrylate, such as, for example, hydroxymethyl (meth)acrylate, hydroxyethyl (meth)acrylate, hydroxypropyl (meth)acrylate, hydroxybutyl (meth)acrylate, hydroxypentyl (meth)acrylate, and the like, as well as combinations thereof.

The (meth)acrylic-functional compound may comprise an epoxy-functional (meth)acrylate. As used herein the term “hydroxyl-functional (meth)acrylate” collectively refers (meth)acrylates which have epoxy functionality, i.e., comprise at least one epoxy functional group in the molecule. The hydroxyl-functional (meth)acrylate may comprise a glycidyl (meth)acrylate.

The composition may comprise the (meth)acrylate-functional compound in an amount of at least 0.5 percent by weight based on total weight of the multi-component composition, such as at least 2 percent by weight. The composition may comprise the (meth)acrylic-functional compound in an amount of no more than 40 percent by weight based on total weight of the multi-component composition, such as no more than 20 percent by weight. The composition may comprise the (meth)acrylic-functional compound in an amount of 0.5 percent by weight to 40 percent by weight based on total weight of the multi-component composition, such as 2 percent by weight to 20 percent by weight.

### Amine-Functional Curing Agents

Suitable amine-functional curing agents for use in the compositions disclosed herein can be selected from a wide variety of known amines such as primary and secondary amines, and mixtures thereof. The amine may include monoamines, or polyamines having at least two functional groups such as di-, tri-, or higher functional amines; and mixtures thereof. The amine may be aromatic or aliphatic such as cycloaliphatic, or mixtures thereof. Non-limiting examples of suitable amines may include aliphatic polyamines such as but not limited to ethylamine, isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, piperazines or adducts or derivatives thereof, or mixtures thereof.

Secondary amines can include polyaspartic esters which can include derivatives of compounds such as maleic acid, fumaric acid esters, aliphatic polyamines and the like, and mixtures thereof. The secondary amine may include an aliphatic amine, such as a cycloaliphatic diamine. Such amines are available commercially from Huntsman Corporation (Houston, Tex.) under the designation of JEFFLINK such as JEFFLINK 754 from BASF as Baxxoder PC136.

The amine can include an amine-functional resin. Suitable amine-functional resins can be selected from a wide variety known in the art. The amine-functional resin may be an ester of an organic acid, for example, an aspartic ester-based amine-functional reactive resin that is compatible with isocyanate. The isocyanate may be solvent-free, and/or may have a mole ratio of amine-functionality to the ester of no more than 1:1 so that no excess primary amine remains upon reaction. A non-limiting example of such polyaspartic esters may include the derivative of diethyl maleate and 1,5-diamino-2-methylpentane, which is available commercially from Covestro under the trade name DESMOPHEN NH1220 and the derivative of diethyl maleate and 4,4′-methylenebis (cyclohexan-1-amine), commercially available as Desmophen NH1420 (Covestro). Other suitable compounds containing aspartate groups may be employed as well.

The amine may include high molecular weight primary amine, such as but not limited to polyoxyalkyleneamine. Suitable polyoxyalkyleneamines may contain two or more primary amino groups attached to a backbone derived, for example, from propylene oxide, ethylene oxide, or mixtures thereof. Non-limiting examples of such amines may include those available under the designation JEFFAMINE from Huntsman Corporation. Such amines may have a number average molecular weight ranging from 200 to 7500, such as but not limited to JEFFAMINE D-230, D-400, D-2000, T-403, T-5000, XJS-616, and ED600. Other suitable amines include aliphatic and cycloaliphatic polyamines such as the Ancamine® series available from Evonik.

The multi-component compositions disclosed herein may comprise the amine-functional curing agent in an amount of at least 3 percent by weight based on total weight of the multi-component composition, such as at least 5 percent by weight. The multi-component compositions disclosed herein may comprise the amine-functional curing agent in an amount of no more than 40 percent by weight based on total weight of the multi-component composition, such as no more than 20 percent by weight. The multi-component compositions disclosed herein may comprise the amine-functional curing agent in an amount of 3 percent by weight to 40 percent by weight based on total weight of the multi-component composition, such as 5 percent by weight to 20 percent by weight.

### Accelerators

The multi-component composition may comprise an accelerator. Any accelerator capable of accelerating the curing of the multi-component composition may be used in the present disclosure. Suitable accelerators include metal-based accelerators and non-metal-based accelerators.

The metal-based accelerators may be metal salts or bases or organometallic species. Examples of suitable metal-based accelerators include but are not limited to tin-based accelerators, zinc-based accelerators, zirconium-based accelerators, bismuth-based accelerators, titanium-based accelerators, potassium-based accelerators, or combinations thereof. Examples of suitable tin-based accelerators include but are not limited to dibutyltin diacetylacetonate, dimethyltin diacetate, dimethyltin bis(acetylacetonate), dibutyltin dilaurate, dibutyltin maleate, dibutyltin phthalate, dibutyltin dioctanoate, dibutyltin bis(2-ethyl-hexanoate), dibutyltin bis(methylmaleate), dibutyltin bis(ethylmaleate), dibutyltin bis(butylmaleate), dibutyltin bis(octylmaleate), dibutyltin bis(tridecylmaleate), dibutyltin bis(benzylmaleate), dibutyltin diacetate, dioctyltin bis(triethoxysilicate), dioctyltin bis(ethylmaleate), dioctyltin bis(octylmaleate), dibutyl tin dimethoxide, dibutyl tin bis(nonylphenoxide), dibutenyl tin oxide, dibutyl tin oxide, reaction product of dibutyltin oxide and silicate compound, reaction product of dibutyltin oxide and phthalic acid ester, dioctyltin dilaurate, dioctyltin oxide, dioctyltin diacetate, or dioctyltin bis(acetylacetonate); tin carboxylate; or combinations thereof. Examples of suitable zinc-based accelerators include but are not limited to the zinc salt of mercaptobenzothiazole (ZMBT); zinc dialkyl dithiocarbamates, such as dimethyl-dithiocarbamate (ZDMC), diethyl-dithiocarbamate (ZDEC), and dibutyl-dithiocarbamate (ZDBC); zinc salts of xanthic acid, zinc bis(2-ethylhexanoate), zinc neodecanoate, zinc octoate, zinc acetylacetonate, zinc oxalate, zinc acetate, or combinations thereof. Examples of suitable zirconium-based accelerators include but are not limited to zirconium tetrakis (acetylacetonate), zirconium carboxylate, zirconium octoate, zirconium ethyl acetylacetonate complex, or combinations thereof. Examples of suitable bismuth salts include but are not limited to bismuth tris(neodecanoate), bismuth tris(2-ethylhexanoate), bismuth oxide, and other bismuth carboxylates, or combinations thereof. Examples of suitable titanium-based accelerators include but are not limited to tetraisopropyl orthotitanate, titanium oxyacetylacetonate, titanium triethanolamine, and titanium ethylacetylacetonate. Examples of suitable potassium-based accelerators include but are not limited to potassium salts of carboxylic acids such as potassium neodecanoate.

Examples of suitable commercial products that may be used include FASCAT 4203 from Arkema; Neostann U220-H available from Kaneka; K-Kat 4205, K-Kat 6212, K-Kat XK-635, K-Kat XK-651, K-Kat 670, K-Kat XK-672 available from King Industries; Perkacit ZDEC and Perkacit ZBEC available from Performance Chemicals; and TIB KAT 218, TIB KAT 223, TIB KAT 616, TIB KAT 720, TIB KAT 725, and TIB Kat K25 available from TIB Chemicals.

Examples of suitable non-metal-based accelerators are amine-based accelerators and acid-based accelerators. Examples of amines that may be useful comprise quaternary amines, tertiary amines, cyclic tertiary amines, secondary amines, cyclic secondary amines, and primary amines. Some examples include trimethylamine, butylamine, tributylamine, octylamine, laurylamine, dibutylamines, monoethanolamines, diethanolamines, triethanolamine, diethylenetriamine, triethylenetetriamine, oleylamines, diethanolamines, triethanolamine, cyclohexylamine, benzylamine, diethylaminopropylamine, xylylenediamine, triethylenediamine, guanidine, dimethylguanidine, tetramethylguanidine, pentamethylguanidine, phenylguanidine, diphenylguanidine, butylbiguanide, 1-o-tolylbiguanide, 1-phenylbiguanide, 1-methyl-3-nitroguanidine, 1,8-bis(tetramethylguanidino)-naphthalene, N,N,N′,N′-tetramethyl-N″-[4-morpholinyl(phenylimino)methyl]guanidine, 2,4,6-tris(dimethylaminomethyl)phenol, 2,2′-dimorpholinodiethylether, morpholine, N-methylmorpholine, 2-ethyl-4-methylimidazole, 1,8-diacabicyclo-(5,4,0)-undecene-7 (DBU), N,N-bis(N,N-dimethyl-2-aminoethyl)methylamine, N,N-dimethylcyclohexylamine, N-methylmorpholine, N-ethylmorpholine, piperidine; piperazine; pyrrolidine, homopiperazine, 1,2-dimethyl-1,4,5,6-tetrahydropyrimidine, 1,4,5,6-tetrahydropyrimidine, 1,8-diazabicyclo[5.4.0]undec-7-ene; 1,5,7-triazabicyclo[4.4.0]dec-5-ene, 7-methyl-1,5,7-triazabicyclo[4.4.0]dec-5-ene, 1,5-diazabicyclo[4.3.0]non-5-ene, 6-(dibutylamino)-1,8-diazabicyclo(5,4,0)undec-7-ene, 1,4-diazabicyclo[2.2.2]octane, 7-azabicyclo[2.2.1]heptane, N, N-dimethylphenylamine, 4,5-dihydro-1H-imidazole, or combinations thereof.

Examples of suitable commercial products that may be used include diethanolamine and triethanolamine T85 available from BASF; and Ancamine K-54, Curezol C17Z, DABCO 33-LV, Polycat DBU, and Vestamin IPD available from Evonik.

If present at all, the multi-component compositions may comprise an accelerator in amount of up to 15 percent by weight based on total weight of the multi-component composition, such as no more than 15 percent by weight, such as no more than 10 percent by weight. If present at all, the multi-component compositions may comprise an accelerator in an amount of at least 0.1 percent by weight, such as at least 2 percent by weight. If present at all, the multi-component compositions may comprise the accelerator in an amount of 0.1 percent by weight to 15 percent by weight based on total weight of the multi-component composition, such as at least 2 percent by weight to 10 percent by weight.

### Flame Retardants

The compositions provided by the present disclosure can comprise a flame retardant or combination of flame retardants. As used herein, “flame retardant” refers to a material that slows down or stops the spread of fire or reduces its intensity. Flame retardants may be available as a powder that may be mixed with a composition, a foam, or a gel. In examples, when the compositions disclosed herein include a flame retardant, such compositions may form a coating on a substrate surface and such coating may function as a flame retardant.

Suitable examples of flame retardants include aluminum hydroxide and magnesium hydroxide.

As set forth in more detail below, a flame retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Such halogenated flame retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable flame retardants include ammonium polyphosphate and barium sulfate.

The multi-component composition may comprise the flame retardant in an amount up to 30 percent by weight based on total weight of the composition. If present at all, the multi-component composition may comprise the flame retardant in an amount of at least 1 percent by weight based on total weight of the composition, such as at least 3 percent by weight. The composition may comprise the flame retardant in an amount of no more than 30 percent by weight based on total weight of the composition, such as no more than 20 percent by weight. If present at all, the composition may comprise the flame retardant in an amount of 1 percent by weight to 30 percent by weight based on total weight of the composition, such as 3 percent by weight to 20 percent by weight.

### Adhesion Promoters

The compositions disclosed herein also may comprise an adhesion promoter. Suitable adhesion promoters include phenolics, such as Methylon® phenolic resin, and organosilanes, such as epoxy, mercapto, or amino functional silanes such as those described in U.S. Pat. No. 11,066,584, column 18, line 61 to column 19, line 59, incorporated herein by reference. Useful examples of amino functional silanes include Silquest® A-187 and Silquest® A-1100. Other suitable adhesion promoters include alkyls, titanates and zirconates. Other useful adhesion promoters are known in the art.

If present at all, the multi-component compositions may comprise the adhesion promoter in an amount of no more than 15 percent by weight based on total weight of the composition. If present at all, the multi-component compositions may comprise the adhesion promoter in an amount of at least 0.1 percent by weight based on total weight of the composition, such as at least 0.2 percent by weight. The composition may comprise the adhesion promoter in an amount of no more than 15 percent by weight based on total weight of the composition, such as no more than 10 percent by weight. If present at all, the composition may comprise the adhesion promoter in an amount of 0.1 percent by weight to 15 percent by weight based on total weight of the composition, such as 0.2 percent by weight to 10 percent by weight.

### Reinforcing Fillers

Compositions disclosed herein may comprise at least one reinforcing filler. As used herein, “reinforcing fillers” exclude “lightweight fillers” as defined below. That is, as used herein, the term “reinforcing” when used with reference to particles of the present disclosure means that the particles have a specific gravity of more than 1.0 when measured according to ASTM D5965, with “specific gravity” being the ratio of a mass of a solid or liquid (e.g., a mass of particles) to a mass of an equal volume of distilled water at the same temperature (e.g., 25° C.).

Useful reinforcing fillers include carbon black, calcium carbonate, precipitated calcium carbonate, calcium hydroxide, calcium silicates, aluminum powders, hydrated alumina (aluminum hydroxide), metal oxides, fumed silica, fused silica, silica, precipitated silica, and combinations of any of the foregoing.

Examples include calcium silicate having a specific gravity of 2.1 to 2.2 and a particle size of 3 to 4 microns (HUBERSORB HS-600®, J. M. Huber Corp.) and fumed silica having a specific gravity of 1.7 to 1.8 with a particle size less than 1 (CAB-O-SIL TS-720®, Cabot Corp.). Other examples include precipitated silica having a specific gravity of 2 to 2.1 (HI-SIL TS-7000®, PPG Industries), and polyethylene having a specific gravity of 1 to 1.1 and a particle size of 10 to 20 microns (SHAMROCK S-395®, Shamrock Technologies Inc.). Amorphous particles may comprise fumed silica. Fumed silica could be hydrophilic or hydrophobic and coated or uncoated. Examples can comprise AEROSIL® fumed silicas from Evonik or HDK® from Wacker Chemie AG. Examples can comprise Sipernat precipitated silicas from Evonik.

If present at all, the multi-component compositions may comprise the reinforcing filler in an amount up to 50 percent by weight based on total weight of the multi-component composition, such as at least 0.1 percent by weight, such as at least 0.2 percent by weight. The multi-component compositions may comprise reinforcing filler in an amount of no more than 50 percent by weight based on total weight of the composition, such as no more than 30 percent by weight. If present at all, the multi-component compositions may comprise the reinforcing filler in an amount of 0.1 percent by weight to 50 percent by weight based on total weight of the composition, such as 0.2 percent by weight to 30 percent by weight.

### Lightweight Fillers

The multi-component compositions may comprise lightweight fillers. Lightweight fillers may be organic, inorganic, or combinations thereof. As used herein, the term “lightweight” when used with reference to particles of the present disclosure means that the particles have a specific gravity of no more than 1.0 when measured according to ASTM D5965, with “specific gravity” being the ratio of a mass of a solid or liquid (e.g., a mass of particles) to a mass of an equal volume of distilled water at the same temperature (e.g., 25° C.). The lightweight fillers may have a specific gravity of at least 0.01 measured according to ASTM D5%5, such as at least 0.02, such as at least 0.1. The lightweight fillers may have a specific gravity of no more than 1.0 measured according to ASTM D5%5, such as no more than 0.7. The lightweight fillers may have a specific gravity of 0.01 to 1.0 measured according to ASTM D5%5, such as 0.02 to 0.7.

Suitable lightweight fillers may comprise microspheres. Useful examples of lightweight fillers include polystyrene foam, microspheres of polyacrylates and polyolefins, and silica microspheres having particle sizes of 5 to 100 microns and a specific gravity of 0.25 (ECCOSPHERES®, Trelleborg Applied Technologies). Other examples include alumina/silica microspheres having particle sizes 5 to 300 microns and a specific gravity of 0.7 (FILLITE®, Pluess-Stauffer International), aluminum silicate microspheres having a specific gravity of 0.45 to about 0.7 (Z-LIGHT®), and calcium carbonate-coated polyvinylidene copolymer microspheres having a specific gravity of 0.13 (DUALITE 6001AE®, Pierce & Stevens Corp.). Other suitable lightweight fillers include, for example, hollow microspheres such as Expancel® microspheres (available from Nouryon) or Dualite® low density polymer microspheres (available from Henkel) or hollow borosilicate glass, such as 3M Glass bubbles type VS, K series and S series available from 3M. Compositions provided by the present disclosure include lightweight filler particles comprising an exterior surface coated with a thin coating, such as those described in U.S. Publication No. 2010/0041839 at paragraphs [0016]-[0052], the cited portion of which is incorporated herein by reference.

Suitable lightweight fillers include, for example, those described in: U.S. Pat. No. 6,525,168, column 4, lines 14-55, incorporated herein by reference; and U.S. Pat. No. 8,816,023, column 3, line 18 to column 9, line 44, incorporated herein by reference.

If present at all, the multi-component compositions may comprise no more than 70 percent by weight of lightweight filler based on total weight of the composition, such as no more than 30 percent by weight. If present at all, the multi-component compositions may comprise lightweight fillers in an amount of at least 0.1 percent by weight based on total weight of the composition, such as at least 0.2 percent by weight. If present at all, the multi-component compositions may comprise the lightweight filler in an amount of 0.1 percent by weight to 70 percent by weight based on total weight of the composition, such as 0.2 percent by weight to 30 percent by weight.

### Additives

Compositions provided by the present disclosure may further include one or more additives, including by way of non-limiting examples, colorants, thixotropic agents, solvents, plasticizers, reactive diluents, pigments, masking agents, or a combination of any of the foregoing.

If present at all, the multi-component compositions may comprise no more than 20 percent by weight of total additives based on total weight of the composition, such as no more than 10 percent by weight. If present at all, the multi-component compositions may comprise additives in a total amount of at least 0.1 percent by weight based on total weight of the composition, such as at least 0.2 percent by weight. If present at all, the multi-component compositions may comprise additives in a total amount of 0.1 percent by weight to 20 percent by weight based on total weight of the composition, such as 0.2 percent by weight to 10 percent by weight.

### Compositions, Coatings and Systems

The compositions disclosed herein may be provided as multi-component compositions.

A first component may comprise, or consist essentially of, or consist of, an epoxy-functional compound, elastomeric particles, a (meth)acrylic functional compound. A first component optionally may comprise fire retardants, adhesion promoters, reinforcing fillers, lightweight fillers, and/or additives. A second component may comprise, or consist essentially of, or consist of, an amine-functional curing agent. A second component optionally may comprise fit retardants, adhesion promoters, reinforcing fillers, lightweight fillers, and/or additives. Additional components (i.e., third components, fourth components, etc.) may comprise, or consist essentially of, or consist of, fire retardants, adhesion promoters, reinforcing fillers, lightweight fillers, and/or additives.

The compositions disclosed herein may be applied alone or as part of a coating system. Compositions disclosed herein may be applied directly onto the surface of a substrate or over an underlayer by any suitable coating process. Compositions can be deposited on substrates in a number of different ways, non-limiting examples of which include brushes, rollers, films, pellets, pressure injectors, spray guns and applicator guns. The system may comprise a number of the same or different layers and may further comprise other coating compositions such as pretreatment compositions, primers, and the like. A coating, film, layer or the like is typically formed when a composition that is deposited onto the substrate is at least partially cured by methods known to those of ordinary skill in the art (e.g., under ambient conditions and may further cure by through the use of an external energy source such as an oven or other thermal means or through the use of actinic radiation) to form a coating, layer or film. A multi-component composition may at least partially cure at ambient temperature. Compositions may be cured at a temperature of 0 to 40° C., such as 10° C. to 25° C., and atmospheric humidity. A composition may be cured at a higher temperature such as at least 30° C., at least 40° C., or at least 50° C. When cured at room temperature a coating provided by the present disclosure can cure to a tack free surface, for example, within 24 hours, within 20 hours, within 16 hours, within 12 hours, within 6 hours, or within 3 hours, from the time of mixing. The skilled person understands, however, that the time of curing varies with temperature.

The amine-functional curing agent may be present in the composition in an amount sufficient to provide a molar ratio of epoxide functional groups from the epoxy-containing compound to amine-hydrogens from the amine-containing curing agent of at least 0.5:1.0, such as at least 0.75:1.0. The amine-functional curing agent may be present in the composition in an amount sufficient to provide a molar ratio of epoxide functional groups from the epoxy-containing compound to amine-hydrogens from the amine-containing curing agent of no more than 2.0:1.0, such as no more than 1.25:1.0. The amine-functional curing agent may be present in the composition in an amount sufficient to provide a molar ratio of epoxide functional groups from the epoxy-containing compound to amine-hydrogens from the amine-containing curing agent 0.5:1.0 to 2.0:1.0, such as 0.75:1.0 to 1.25:1.0.

The multi-component compositions disclosed herein may comprise a gel time of no more than 20 minutes following mixing of the first component and the second component at 77° F.

Without being bound by theory, it is believed that the first component and the second component may be crosslinked by a Michael addition reaction between the (meth)acrylic-functional groups of the (meth)acrylic-functional compound and the amino functional group of the amine-functional group. As used herein, a “Michael addition reaction” means a reaction between an electrophile and a nucleophile, wherein the nucleophile undergoes conjugate addition to a double bond of a conjugated system.

The multi-component compositions disclosed herein may comprise a coating composition, such as an adhesive composition, a sealant composition, an embedding composition, an encapsulating composition, and/or a potting composition.

In an at least partially cured state, the compositions may form a coating, such as an adhesive, a sealant, an embedding material, an encapsulating material, and/or a potting compound.

It was surprisingly discovered that the coatings formed from the compositions disclosed herein, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section, such as at least 7.8 ksi;
(b) a compressive modulus of at least 200 ksi measured according to ASTM D695 with sample dimensions of 1.0 inch in height and 0.5 inch by 0.5 inch for cross-section, such as at least 210 ksi, such as at least 220 ksi;
(c) a lap shear strength of at least 1800 psi measured according to ASTM D1002; and
(d) an actual density of at least 0.670 g/ml measured according to ASTM D792 or ASTM D1622.

Also disclosed herein are uses of the compositions disclosed herein for making a coating, wherein the coating, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section, such as at least 7.8 ksi;
(b) a compressive modulus of at least 200 ksi measured according to ASTM D695 with sample dimensions of 1.0 inch in height and 0.5 inch by 0.5 inch for cross-section, such as at least 210 ksi, such as at least 220 ksi;
(c) a lap shear strength of at least 1800 psi measured according to ASTM D1002; and
(d) an actual density of at least 0.670 g/ml measured according to ASTM D792 or ASTM D1622.

Also disclosed herein are uses of a coating formed from the any of the compositions disclosed herein, to provide a substrate comprising a coating, wherein the coating, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section, such as at least 7.8 ksi;
(b) a compressive modulus of at least 200 ksi measured according to ASTM D695 with sample dimensions of 1.0 inch in height and 0.5 inch by 0.5 inch for cross-section, such as at least 210 ksi, such as at least 220 ksi;
(c) a lap shear strength of at least 1800 psi measured according to ASTM D1002; and (d) an actual density of at least 0.670 g/ml measured according to ASTM D792 or ASTM D1622.

### 3D Printing

Compositions of the present disclosure may be applied or deposited using any suitable method, including those aforementioned. Alternatively, the composition may be casted, extruded, molded, or machined to form a part or a member in at least partially dried or cured state.

The compositions disclosed herein may be used in any suitable additive manufacturing technology, such as three-dimensional (3D) printing, extrusion, jetting, and binder jetting. Additive manufacturing refers to a process of producing a part or member by constructing it in layers, such as one layer at a time.

The present disclosure is also directed to the production of structural articles, such as by way of a non-limiting example, sound damping pads, using an additive manufacturing process, such as 3D printing. 3D printing refers to a computerized process, optionally including artificial intelligence modulation, by which materials are printed or deposited in successive layers to produce a 3D part or member, such as, by way of a non-limiting example, sound damping pads in a battery assembly. A 3D part or member may be produced by depositing successive portions or layers over a base of any spatial configuration and thereafter depositing additional portions or layers over the underlying deposited portion or layer and/or adjacent to the previously deposited portion or layer to produce the 3D printed part or member.

It will be appreciated that the configuration of the 3D printing process, including the selection of suitable deposition equipment, depends on a number of factors such as the deposition volume, the viscosity of the composition and the complexity of the part being fabricated. Any suitable mixing, delivery, and 3D printing equipment as known to those skilled in the art, may be used. Compositions may be printed or deposited in any size and/or shape of droplets or extrudate, and in any patterns to produce the 3D structure.

Compositions as disclosed herein may be applied or deposited by any suitable 3D printing method as known to those skilled in the art. First and second components of 2K compositions may be mixed and then deposited, or the first and second components may be deposited separately, such as simultaneously and/or sequentially.

First and second components may be premixed, i.e., mixed together, prior to application, and then deposited. The mixture may be at least partially reacted or thermoset when the material is deposited; the deposited reaction mixture may react at least in part after deposition and may also react with previously deposited portions and/or subsequently deposited portions of the article such as underlying layers or overlying layers of the article.

In a non-limiting example, the first and two components may be released from their individual storage containers and pushed, such as pumped through conduits, such as hoses, to a mixer, such as a static or dynamic mixer, wherein the composition may be mixed for a time sufficient to homogenize the composition, wherein the composition may then be released through an outlet. The outlet may be a deposition device, such as a printing head, and/or the materials may exit the mixing unit and be pushed, such as by a pump, through a conduit, such as a hose, to the printing head. The printing head may optionally be mounted on a 3D rotational robotic arm to allow delivery of 3D print compositions to any base in any spatial configuration and/or the base may be manipulated in any spatial configuration during the 3D printing process.

Alternatively, first and second components may be deposited independently from different printing heads. The first component may be deposited from one printing head and the second component may be deposited from a second printing head. The first and second components may be deposited in any pattern such that the first and second components comprising any deposited layer can react together as well as react with underlying and/or overlying layers to produce the 3D printed part or member.

Methods provided by the present disclosure include printing the composition on a fabricated part. Methods provided by the present disclosure include directly printing parts.

Using the methods provided by the present disclosure parts can be fabricated. The entire part can be formed from one of the compositions disclosed herein, one or more portions of a part can be formed from one of the compositions disclosed herein, one or more different portions of a part can be formed using the compositions disclosed herein, and/or one or more surfaces of a part can be formed from a composition provided by the present disclosure. In addition, internal regions of a part can be formed from a composition provided by the present disclosure.

### Substrates

Still further disclosed are substrates and articles comprising, or consisting essentially of, or consisting of, coatings formed from the compositions disclosed herein. For example, also disclosed is a coated substrate, wherein at least a portion of a surface of the substrate is at least partially coated with a coating formed from a composition disclosed herein. Also disclosed is an article comprising, or consisting essentially of, or consisting of, first and second substrates and a coating positioned therebetween and in an at least partially cured state.

The substrates that may be coated by the compositions of the present disclosure are not limited. Suitable substrates useful in the present disclosure include, but are not limited to, materials such as metals or metal alloys, ceramic materials such as boron carbide or silicon carbide, polymeric materials such as hard plastics including filled and unfilled thermoplastic materials or thermoset materials, or composite materials. Other suitable substrates useful in the present disclosure include, but are not limited to, glass or natural materials such as wood. For example, suitable substrates include rigid metal substrates such as ferrous metals, aluminum, aluminum alloys, magnesium titanium, copper, and other metal and alloy substrates. The ferrous metal substrates used in the practice of the present disclosure may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. Aluminum alloys of the 1XXX, 2XXX, 3XXX, 4XXX, 5XXX, 6XXX, 7XXX, or 8XXX series as well as clad aluminum alloys and cast aluminum alloys of the A356, 1XX.X, 2XX.X, 3XX.X, 4XX.X, 5XX.X, 6XX.X, 7XX.X, or 8XX.X series also may be used as the substrate. Magnesium alloys of the AZ31B, AZ91C, AM60B, or EV31A series also may be used as the substrate. The substrate used in the present disclosure may also comprise titanium and/or titanium alloys of grades 1-36 including H grade variants. Other suitable non-ferrous metals include copper and magnesium, as well as alloys of these materials. The compositions disclosed herein are particularly suitable for use in various industrial or transportation applications including automotive, light and heavy commercial vehicles, marine, or aerospace. Suitable metal substrates for use in the present disclosure include those that are used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, and industrial structures and components. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be converted, anodized, primed, organic-coated or chromate-coated, epoxy, urethane, graphite, fiberglass composite, Kevlar®, acrylics, and polycarbonates. The substrate may comprise a composite material such as a plastic or a fiberglass composite. The substrate may be a fiberglass and/or carbon fiber composite. The first and second substrates may be made of the same material or may be made of dissimilar materials. For example, a first substrate and a second substrate may be a metal and a plastic; two dissimilar plastics; a metal or a plastic and a reinforced plastic composite; or two dissimilar plastic composites.

In view of the foregoing description the present disclosure thus relates in particular to the following Aspects 1-28 without being limited thereto.

### ASPECTS

Aspect 1. A multi-component composition comprising:
a first component comprising:
   an epoxy-functional compound;
   elastomeric particles; and
      a (meth)acrylic-functional compound; and
   a second component comprising:
      an amine-functional curing agent.

Aspect 2. The multi-component composition of aspect 1, wherein the epoxy-functional compound comprises a diglycidyl ether of bisphenol A, a diglycidyl ether of bisphenol F, a novolac epoxy, a silane-functional epoxy or combinations thereof.

Aspect 3. The multi-component composition of aspect 1 or aspect 2, comprising the epoxy-functional compound in an amount of at least 0.5 percent by weight based on total weight of the multi-component composition, such as at least 5 percent by weight, such as no more than 60 percent by weight, such as no more than 40 percent by weight, such as 0.5 percent by weight to 60 percent by weight, such as 5 percent by weight to 40 percent by weight based.

Aspect 4. The multi-component composition of any preceding aspect, wherein the elastomeric particles comprise a silicone material, a polybutadiene core, a styrene butadiene core, a polyisoprene core, and/or a styrene isoprene core.

Aspect 5. The multi-component composition of any of the preceding aspects, wherein the elastomeric particles comprise a (meth)acrylic shell.

Aspect 6. The multi-component composition of any of the preceding aspects, wherein the elastomeric particles comprise a core comprising a Tg less than 0° C. measured by DMA or DSC, such as −20° C. or lower, such as −40° C. or lower, such as −60° C. or lower, such as −70° C. or lower, such as −70° C. to 0° C.

Aspect 7. The multi-component composition of any of the preceding aspects, comprising the elastomeric particles in an amount of at least 2 percent by weight based on total weight of the multi-component composition, such as at least 3 percent by weight, such as at least 5 percent by weight, such as no more than 40 percent by weight, such as no more than 35 percent by weight, such as no more than 25 percent by weight, such as 2 percent by weight to 40 percent by weight, such as 3 percent by weight to 35 percent by weight, such as 5 percent by weight to 25 percent by weight.

Aspect 8. The multi-component composition of any of the preceding aspects, wherein the (meth)acrylic-functional compound comprises at least 3 (meth)acrylic functional groups per molecule.

Aspect 9. The multi-component composition of any of the preceding aspects, wherein the (meth)acrylic-functional compound comprises a functional group in addition to the (meth)acrylic functional group, such as a hydroxy functional group, an epoxy functional group, an isocyanato functional group, a tertiary amine functional group, an ether linkage and/or an ester linkage.

Aspect 10. The multi-component composition of any of the preceding aspects, wherein the (meth)acrylic-functional compound comprises dimethylolpropane tetra(meth)acrylate, pentaerythritol tetra(meth)acrylate, trimethylpropane tri(meth)acrylate, dipentaerythritol penta(meth)acrylate, dipentaerythritol hexa(meth)acrylate, and/or tris[2-((meth)acryloyloxy)ethyl]isocyanurate.

Aspect 11. The multi-component composition of any of the preceding aspects, comprising the (meth)acrylic-functional compound in an amount of 0.5 percent by weight based on total weight of the multi-component composition, such as at least 2 percent by weight, such as no more than 40 percent by weight, such as no more than 20 percent by weight, such as 0.5 percent by weight to 40 percent by weight, such as 2 percent by weight to 20 percent by weight.

Aspect 12. The multi-component composition of any of the preceding aspects, wherein the amine-functional curing agent comprises a primary amine and/or a secondary amine, such as an aliphatic or cycloaliphatic polyamine.

Aspect 13. The multi-component composition of any of the preceding aspects, comprising the amine-functional curing agent in an amount of at least 3 percent by weight based on total weight of the multi-component composition, such as at least 5 percent by weight, such as no more than 40 percent by weight, such as no more than 20 percent by weight, such as 3 percent by weight to 40 percent by weight, such as 5 percent by weight to 20 percent by weight.

Aspect 14. The multi-component composition of any of the preceding aspects, further comprising an accelerator such as metal-based accelerator and/or a non-metal-based accelerator, a flame retardant, an adhesion promoter, a reinforcing filler and/or an additive, such as:
(a) the accelerator in an amount of at least 0.1 percent by weight based on total weight of the multi-component composition, such as at least 2 percent by weight, such as no more than 15 percent by weight, such as no more than 10 percent by weight, such as 0.1 percent by weight to 15 percent by weight, such as 2 percent by weight to 10 percent by weight;
(b) the flame retardant in an amount of at least 1 percent by weight based on total weight of the multi-component composition, such as at least 3 percent by weight, such as no more than 30 percent by weight, such as no more than 20 percent by weight, such as 1 percent by weight to 30 percent by weight, such as 3 percent by weight to 20 percent by weight;
(c) the adhesion promoter in an amount of at least 0.1 percent by weight based on total weight of the multi-component composition, such as at least 0.2 percent by weight, such as no more than 15 percent by weight, such as no more than 10 percent by weight, such as 0.1 percent by weight to 15 percent by weight, such as 0.2 percent by weight to 10 percent by weight;
(d) the reinforcing filler in an amount of at least 0.1 percent by weight based on total weight of the multi-component composition, such as at least 0.2 percent by weight, such as no more than 50 percent by weight, such as no more than 30 percent by weight, such as 0.1 percent by weight to 50 percent by weight, such as 0.2 percent by weight to 30 percent by weight; and/or
(e) the additive in an amount of at least 0.1 percent by weight based on total weight of the multi-component composition, such as at least 0.2 percent by weight, such as no more than 20 percent by weight, such as no more than 10 percent by weight, such as 0.1 percent by weight to 20 percent by weight, such as 0.2 percent by weight to 10 percent by weight.

Aspect 15. The multi-component composition of any of the preceding aspects, comprising the amine-functional curing agent may in an amount sufficient to provide a molar ratio of epoxide functional groups from the epoxy-containing compound to amine-hydrogens from the amine-containing curing agent of at least 0.5:1.0, such as at least 0.75:1.0, such as no more than 2.0:1.0, such as no more than 1.25:1.0, such as 0.5:1.0 to 2.0:1.0, such as 0.75:1.0 to 1.25:1.0.

Aspect 16. The multi-component composition of any of the preceding aspects, comprising a gel time of no more than 20 minutes following mixing of the first component and the second component at 77° F.

Aspect 17. A method of coating a substrate comprising contacting at least a portion of a surface of the substrate with the composition of any of the preceding aspects.

Aspect 18. The method of aspect 17, further comprising contacting a surface of a second substrate to the composition such that the composition is between the first and second substrates.

Aspect 19. A substrate comprising a coating formed on a surface thereof, wherein the coating is formed from the composition of any of aspects 1 to 16.

Aspect 20. The substrate of aspect 19, wherein the substrate comprises a vehicle.

Aspect 21. The substrate of any of aspect 19 or aspect 20, wherein the vehicle comprises an aircraft.

Aspect 22. The substrate of any of aspects 19 to 21, wherein the substrate comprises aluminum or an alloy thereof.

Aspect 23. The substrate of aspect 22, wherein the alloy comprises copper.

Aspect 24. The substrate of any of aspects 19 to 23, wherein the coating, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section, such as at least 7.8 ksi;
(b) a compressive modulus of at least 200 ksi measured according to ASTM D695 with sample dimensions of 1.0 inch in height and 0.5 inch by 0.5 inch for cross-section, such as at least 210 ksi, such as at least 220 ksi;
(c) a lap shear strength of at least 1800 psi measured according to ASTM D1002; and
(d) an actual density of at least 0.670 g/ml measured according to ASTM D792 or ASTM D1622.

Aspect 25. A method of forming an article comprising extruding the composition of any of aspects 1 to 16, such as wherein the extruding comprises three-dimensional printing.

Aspect 26. The article of aspect 25, wherein the article, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section, such as at least 7.8 ksi;
(b) a compressive modulus of at least 200 ksi measured according to ASTM D695 with sample dimensions of 1.0 inch in height and 0.5 inch by 0.5 inch for cross-section, such as at least 210 ksi, such as at least 220 ksi;
(c) a lap shear strength of at least 1800 psi measured according to ASTM D1002; and
(d) an actual density of at least 0.670 g/ml measured according to ASTM D792 or ASTM D1622.

Aspect 27. A use of the composition of any of aspects 1 to 16, for making a coating, wherein the coating, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section, such as at least 7.8 ksi;
(b) a compressive modulus of at least 200 ksi measured according to ASTM D695 with sample dimensions of 1.0 inch in height and 0.5 inch by 0.5 inch for cross-section, such as at least 210 ksi, such as at least 220 ksi;
(c) a lap shear strength of at least 1800 psi measured according to ASTM D1002; and
(d) an actual density of at least 0.670 g/ml measured according to ASTM D792 or ASTM D1622.

Aspect 28. A use of a coating formed from the composition of any of aspects 1 to 16 to provide a substrate comprising a coating comprising a coating which, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section, such as at least 7.8 ksi;
(b) a compressive modulus of at least 200 ksi measured according to ASTM D695 with sample dimensions of 1.0 inch in height and 0.5 inch by 0.5 inch for cross-section, such as at least 210 ksi, such as at least 220 ksi;
(c) a lap shear strength of at least 1800 psi measured according to ASTM D1002; and
(d) an actual density of at least 0.670 g/ml measured according to ASTM D792 or ASTM D1622.

The following examples are intended to illustrate the disclosure and should not be construed as limiting the disclosure in any way.

### EXAMPLES

### Example 1 Epoxy Amine Syntactic Foam Adhesives

Syntactic foam adhesives were prepared using epoxy-amine compositions and an acrylate, core-shell rubber particles, or both an acrylate and core-shell rubber particles, as described in this disclosure.

### Preparation of Epoxy Packs (EPOXY 1-5) and Amine Pack (AMINE)

A two-package syntactic foam adhesive composition comprising an amine pack and an epoxy pack was prepared. The amine pack (AMINE) was prepared using the components (shown in percent by weight based on total weight of the amine pack) shown in Table 1. The components were added to a container and mixed until the composition was homogenous.

TABLE 1
Amine Pack

| Components | Wt % |
|---|---|
| Mixture of tetraethylenepentamine and tris- | 64.5% |
| (dimethylaminomethyl) phenol | |
| Microspheres | 19.6% |
| Filler | 11.7% |
| Rheology modifiers | 4.2% |

EPOXY Pack 1 was prepared using the components (shown in percent by weight based on total weight) shown in Table 2. The components were added to a container and mixed until the composition was homogenous.

TABLE 2
Epoxy Pack 1

| Components | Wt % |
|---|---|
| Mixture of bisphenol A epoxy | 65.3% |
| and epoxy silane | |
| Microspheres | 17.8% |
| Filler | 13.9% |
| Fumed silica | 3.1% |

EPOXY Packs 2-5 were made using EPOXY 1 and the components and weight ratios shown in Table 3. The components were mixed until homogeneous.

TABLE 3
Epoxy Packs 2-5

| Components | EPOXY 2 | EPOXY 3 | EPOXY 4 | EPOXY 5 |
|---|---|---|---|---|
| EPOXY 1 | 100 | 100 | 100 | 100 |
| Dimethylolpropane | | 5.9 | 5.9 | 5.9 |
| tetraacrylate | | | | |
| Kane Ace MX- | 9.7 | | 9.7 | |
| 154¹ | | | | |
| Kane Ace MX- | | | | 9.7 |
| 153² | | | | |

¹Core-shell rubber particles having a polybutadiene core and dispersed in bisphenol A, available from Kaneka Belgium NV
²Core-shell rubber particles having a polybutadiene core and dispersed in bisphenol A, available from Kaneka Belgium NV

### Preparation and Performance of Syntactic Foam Adhesives—Adhesives 1-5

As shown in Table 4, Adhesives 1-5 were prepared using Epoxy Packs 1-5, respectively, and Amine Pack, keeping equivalent ratio of Epoxy Pack to Amine Pack at 1:1.

TABLE 4
Adhesives 1-5

| | ADHE- | ADHE- | ADHE- | ADHE- | ADHE- |
|---|---|---|---|---|---|
| | SIVE | SIVE | SIVE | SIVE | SIVE |
| Component | 1 | 2 | 3 | 4 | 5 |
| Epoxy Pack 1 | X | | | | |
| Epoxy Pack 2 | | X | | | |
| Epoxy Pack 3 | | | X | | |
| Epoxy Pack 4 | | | | X | |
| Epoxy Pack 5 | | | | | X |
| Amine Pack | X | X | X | X | X |

Adhesives 1-5 were evaluated for compressive strength (measured according to ASTM D695 with sample dimensions of 1.0 inch in height and 0.5 inch by 0.5 inch for cross-section), compressive modulus (measured according to ASTM D695 with sample dimensions of 1.0 inch in height and 0.5 inch by 0.5 inch for cross-section), shear strength (measured according to ASTM D1002), and actual density (measured according to ASTM D792 or ASTM D1622). Samples also were measured for gel time, which was the time it took the composition to form a non-fluid mass from the time resin and hardener were mixed and allowed to stand at 77° F.

TABLE 5
Performance of Foam Adhesives 1-5

| | ADHE- | ADHE- | ADHE- | ADHE- | ADHE- |
|---|---|---|---|---|---|
| | SIVE | SIVE | SIVE | SIVE | SIVE |
| Properties | 1 | 2 | 3 | 4 | 5 |
| Actual | 0.642 | 0.667 | 0.656 | 0.687 | 0.683 |
| Density | | | | | |
| (g/ml) | | | | | |
| Gel time | 24 | 28 | 15 | 18 | 18 |
| (min) | | | | | |
| Compressive | 7.17 | 7.44 | 7.59 | 7.85 | 7.74 |
| Strength | | | | | |
| (ksi) | | | | | |
| Compressive | 233 | 198 | 230 | 232 | 222 |
| Modulus | | | | | |
| (ksi) | | | | | |
| Shear | 1129 | 2019 | 1412 | 2079 | 1901 |
| Strength | | | | | |
| (psi) | | | | | |

As shown in Table 5, the addition of core-shell rubber particles (ADHESIVE 2) improved the compressive strength and the shear strength, as compared with the control (ADHESIVE 1), but the gel time was increased, and the compressive modulus was reduced. The addition of an acrylate, ditrimethylolpropane tetraacrylate, (ADHESIVE 3) improved the gel time and compressive strength and showed some improvement in shear strength as compared with the control. ADHESIVE 4 and ADHESIVE 5, each formulated with a combination of an acrylate and core-shell rubber particles, had high shear strength, reduced gel time, and highest compressive strengths.

The addition of an acrylate to a syntactic foam adhesive reduced the gel time. The addition of a toughener, core-shell rubber particles, in combination with an acrylate, showed multiple benefits: reduced gel time, high shear strength and highest compressive strength.

Whereas particular features of the present disclosure have been described above for purposes of illustration, it will be evident to those skilled in the art that numerous variations of the details of the coating composition, coating, and methods disclosed herein may be made without departing from the scope in the appended claims.

1. A multi-component composition comprising:
a first component comprising:
an epoxy-functional compound;
elastomeric particles; and
a (meth)acrylic-functional compound; and
a second component comprising:
an amine-functional curing agent.

2. The multi-component composition of claim 1, further comprising a lightweight filler.

3. The multi-component composition of claim 1, comprising:
(a) the epoxy-functional compound in an amount of 0.5 percent by weight to 60 percent by weight based on total weight of the multi-component composition;
(b) the elastomeric particles in an amount of 2 percent by weight to 40 percent by weight based on total weight of the multi-component composition;
(c) the (meth)acrylic-functional compound in an amount of 0.5 percent by weight to 40 percent by weight based on total weight of the multi-component composition; and/or
(d) the amine-functional curing agent in an amount of 3 percent by weight to 40 percent by weight based on total weight of the multi-component composition.

4. The multi-component composition of claim 1, wherein the elastomeric particles comprise a core comprising a Tg less than 0° C. measured by DMA or DSC.

5. The multi-component composition of claim 1, wherein the (meth)acrylic-functional compound comprises at least 3 (meth)acrylic functional groups per molecule.

6. The multi-component composition of claim 1, wherein the (meth)acrylic-functional compound comprises a functional group in addition to the (meth)acrylic functional group.

7. The multi-component composition of claim 1, wherein the amine-functional curing agent comprises a primary amine and/or a secondary amine.

8. The multi-component composition of claim 2, comprising the lightweight filler in an amount of 0.1 percent by weight to 70 percent by weight based on total weight of the multi-component composition.

9. The multi-component composition of claim 1, further comprising an accelerator, a flame retardant, an adhesion promoter, a reinforcing filler and/or an additive.

10. The multi-component composition of claim 1, comprising the amine-functional curing agent may in an amount sufficient to provide a molar ratio of epoxide functional groups from the epoxy-containing compound to amine-hydrogens from the amine-containing curing agent of 0.5:1.0 to 2.0:1.0.

11. The multi-component composition of claim 1, comprising a gel time of no more than 20 minutes following mixing of the first component and the second component at 77° F.

12. A method of coating a substrate comprising contacting at least a portion of a surface of the substrate with the composition of claim 1.

13. A substrate comprising a coating formed on a surface thereof, wherein the coating is formed from the composition of claim 1.

14. The substrate of claim 13, wherein the substrate comprises a vehicle.

15. The substrate of claim 13, wherein the vehicle comprises an aircraft.

16. The substrate of claim 13, wherein the substrate comprises aluminum or an alloy thereof.

17. The substrate of claim 16, wherein the alloy comprises copper.

18. The substrate of claim 13, wherein the coating, when measured 7 days after mixing the first and second components at ambient conditions, comprises at least two of the following:
(a) a compressive strength of at least 7.7 ksi measured according to ASTM D695 with sample dimensions of 1.0 inch in height and 0.5 inch by 0.5 inch for cross-section;
(b) a compressive modulus of at least 200 ksi measured according to ASTM D695 with sample dimensions of 1.0 inch in height and 0.5 inch by 0.5 inch for cross-section;
(c) a lap shear strength of at least 1800 psi measured according to ASTM D1002; and
(d) an actual density of at least 0.670 g/ml measured according to ASTM D792 or ASTM D1622.

19. A method of forming an article comprising extruding the composition of claim 1.
